(19) United States
(12) Patent Application Publication
(10) Pub. No.: US 2013/0169164 A1
(43) Pub. Date: Jul. 4, 2013

(54) DEVICE AND METHOD FOR PROTECTING EYES

(71) Applicants: Hung-Hsiang SHEN, Yangmei City (TW); Min-Ching LIN, Yangmei City (TW); Chung-I CHIANG, Yangmei City (TW)

(72) Inventors: Hung-Hsiang SHEN, Yangmei City (TW); Min-Ching LIN, Yangmei City (TW); Chung-I CHIANG, Yangmei City (TW)

(73) Assignee: WALSIN LIHWA CORPORATION, Yangmei City (TW)

(21) Appl. No.: 13/372,688

(22) Filed: Feb. 14, 2012

(30) Foreign Application Priority Data
Jan. 4, 2012 (TW) 101100267

(51) Int. Cl. H05B 37/02

(52) U.S. Cl. 315/151

(57) ABSTRACT

A device and method, which are utilized in an optical apparatus, for protecting eyes are disclosed. The optical apparatus includes a scanning-mirror component and a visible light source which is optically coupled to the scanning-mirror component. The optical apparatus emits a visible light beam to the scanning-mirror component by using the visible light source. The scanning-mirror component then reflects the visible light beam to emit the visible light beam to a scanning region. The device and the method for protecting eyes can determine at least one eye region in the scanning region, and then make the optical apparatus stop emitting the visible light beam at least within the eye region.

### CROSS-REFERENCES TO RELATED APPLICATIONS

This application claims the benefit of priority based on Taiwan Patent Application No. 101100267 filed on Jan. 4, 2012, and the disclosures of which are incorporated herein by reference in their entirety.

### BACKGROUND OF THE INVENTION

1. Field of the Invention

The present invention relates to a device and a method for protecting eyes, and more particularly, to a device and a method for protecting eyes for an optical apparatus.

2. Descriptions of the Related Art

Some optical apparatuses (e.g., optical apparatuses for measurement or for projection) emit light beams with high luminance to a specific region. Therefore, if the user's eyes are accidentally exposed to the area of illumination, the user will feel uncomfortable or even be hurt if the light beam is a laser.

Accordingly, an urgent need exists in the art to provide a device and a method for protecting eyes for an optical apparatus, which can protect eyes of a user from being hurt by strong light of the optical apparatus.

### SUMMARY OF THE INVENTION

The primary objective of the present invention is to provide a device and a method for protecting eyes, which can make an optical apparatus stop emitting a visible light beam temporarily when eyes of a user enter a scanning region (i.e., a specific region) of the optical apparatus.

To achieve the aforesaid objective, the present invention provides a device for protecting eyes for an optical apparatus. The optical apparatus includes a scanning-mirror component and a visible light source optically coupled to the scanning-minor component. The optical apparatus emits a visible light beam to the scanning-minor component by using the visible light source. The scanning-mirror component then reflects the visible light beam to emit the visible light beam to a scanning region. The device for protecting eyes comprises an eye identifying module and a controlling module. The eye identifying module is used to determine at least one eye region in the scanning region and has an invisible light source. The invisible light source is optically coupled to the scanning-minor component, and is used to emit an invisible light beam to the scanning-minor component. The scanning-minor component is used to reflect the invisible light beam so that the invisible light beam and the visible light beam are simultaneously emitted to the scanning region. The controlling module is electrically connected to the eye identifying module and the optical apparatus, and is used to generate a controlling signal to the optical apparatus so that the optical apparatus stops emitting the visible light beam at least within the eye region.

To achieve the aforesaid objective, the present invention further provides a method for protecting eyes for an optical apparatus. The optical apparatus includes a scanning-mirror component and a visible light source optically coupled to the scanning-mirror component. The optical apparatus emits a visible light beam to the scanning-minor component by using a visible light source. The scanning-mirror component then reflects the visible light beam to emit the visible light beam to a scanning region. The method for protecting eyes comprises steps: emitting an invisible light beam to the scanning region, wherein the invisible light beam and the visible light beam are simultaneously emitted to the scanning region; receiving a reflective invisible light of the invisible light beam in the scanning region; determining at least one eye region in the scanning region according to the reflective invisible light; and generating a controlling signal to the optical apparatus so that the optical apparatus stops emitting the visible light beam at least within the eye region.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a functional block diagram of the first preferred embodiment of a device for protecting eyes according to the present invention;

FIG. 2 is a schematic view of the first preferred embodiment of the device for protecting eyes according to the present invention;

FIG. 3 is a detailed schematic view of the device for protecting eyes and an optical apparatus shown in FIG. 2;

FIG. 4 is another schematic view of the first preferred embodiment of the device for protecting eyes according to the present invention;

FIG. 5 is a further schematic view of the first preferred embodiment of the device for protecting eyes according to the present invention;

FIG. 6 is a schematic view of the second preferred embodiment of the device for protecting eyes according to the present invention;

FIG. 7 is a schematic view of the third preferred embodiment of the device for protecting eyes according to the present invention;

FIG. 8 is a flowchart diagram of the preferred embodiment of a method for protecting eyes according to the present invention; and

FIG. 9 is a detailed flowchart diagram of step S801 of the method for protecting eyes shown in FIG. 8.

### DESCRIPTION OF THE PREFERRED EMBODIMENT

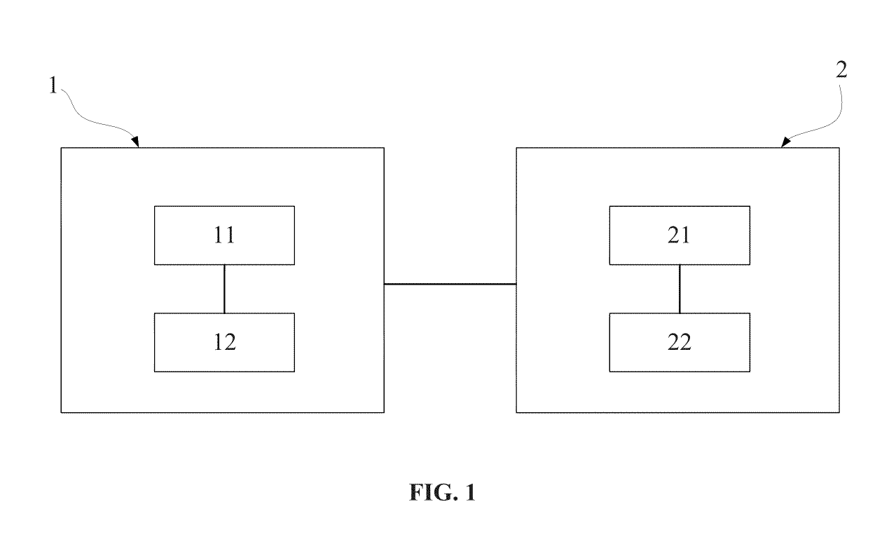

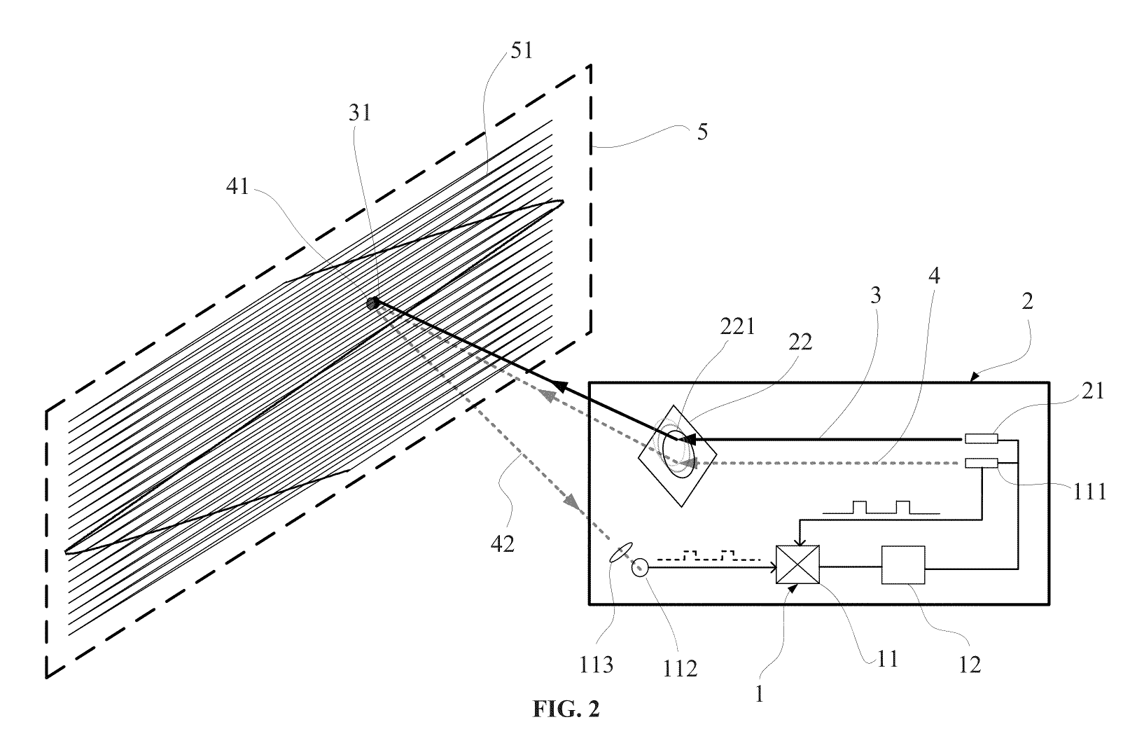

FIGS. 1 and 2 illustrate a functional block diagram and a schematic view of the first preferred embodiment of a device for protecting eyes according to the present invention respectively. The device 1 for protecting eyes may be used in an optical apparatus 2. The optical apparatus 2 may be an optical apparatus capable of emitting a strong light beam such as a projector, a laser pointer or a measuring apparatus; in this embodiment, the optical apparatus 2 is illustrated as a projector.

The optical apparatus 2 includes a visible light source 21 and a scanning-mirror component 22. The visible light source 21 can at least emit a visible light beam 3. The visible light source 21 is optically coupled to the scanning-minor component 22. In other words, the scanning-mirror component 22 is located in an optical path of the visible light beam 3 emitted from the visible light source 21 so that the visible light beam 3 emitted from the visible light source 21 can arrive at the scanning-minor component 22. The visible light source 21 may be a visible laser source, while the visible light beam 3 may be a collimated light beam such as a visible laser beam.

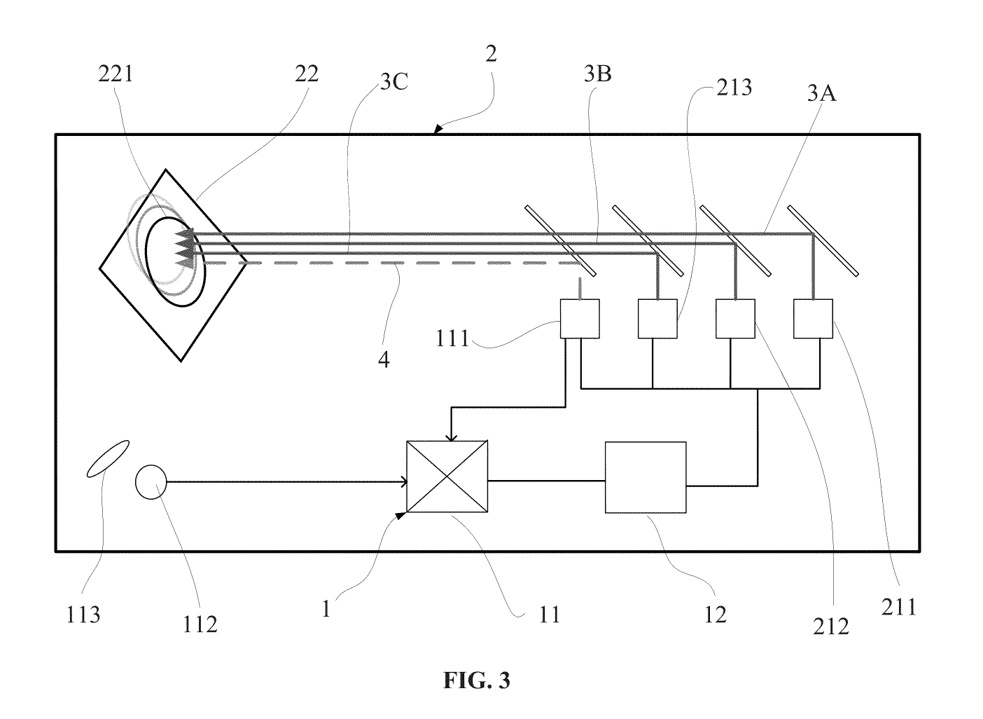

FIG. 3 also illustrates a detailed schematic view of the device for protecting eyes and the optical apparatus shown in FIG. 2. Because the optical apparatus 2 is a projector, the visible light source 21 must be capable of sequentially or simultaneously emitting visible light beams 3 with different colors to project a color image. For this purpose, the visible light source 21 may comprise a red visible light beam generator 211, a green visible light beam generator 212 and a blue visible light beam generator 213. The red visible light beam generator 211, the green visible light beam generator 212 and the blue visible light beam generator 213 may sequentially or simultaneously emit a red visible light beam 3A, a green visible light beam 3B and a blue visible light beam 3C.

It shall be appreciated that if the optical apparatus 2 is not a color projector (such as a laser pointer), the visible light source 21 may only need to emit a monochromatic visible light beam 3.

The scanning-mirror component 22 is a microelectromechanical system (MEMS), and has an electrically driven or magnetically driven reflector 221. The reflector 221 may be driven by an electrostatic force, a magnetic force or a combination of the electrostatic force and the magnetic force. The reflector 221 can rotate or swing with respect to two intersecting axes (not shown). When arriving at the reflector 221 of the scanning-mirror component 22, the visible light beam 3 is reflected to a scanning region 5 to form a visible light spot 31 thereon. When the reflector 221 rotates with respect to the two intersecting axes, the visible light spot 31 formed on the scanning region 5 will move along a scanning trace 51 to form an image. The scanning region 5 is just the distribution region of the scanning trace 51, so the scanning region 5 will become larger when the scanning trace 51 becomes longer.

It shall be appreciated that if the optical apparatus 2 is a laser pointer, when arriving at the reflector 221 of the scanning-mirror component 22, the visible light beam 3 is reflected to a scanning region 5 to form a visible light spot 31 thereon, and then the visible light source 21 is turned off. After the reflector 221 rotates with respect to the two intersecting axes to the original position of the visible light spot 31, the visible light source 21 is again turned on, so the visible light spot 31 projected by the laser pointer could be kept at the same position to realize the function of indicating.

For further description of the scanning-mirror component 22, the reflector 221, the scanning region 5 and the scanning trace 51 described above, reference may be made to at least the following U.S. patent applications: US 2011/0164223, US 2005/0280331, U.S. Pat. No. 6,359,718 and US 2009/0284622.

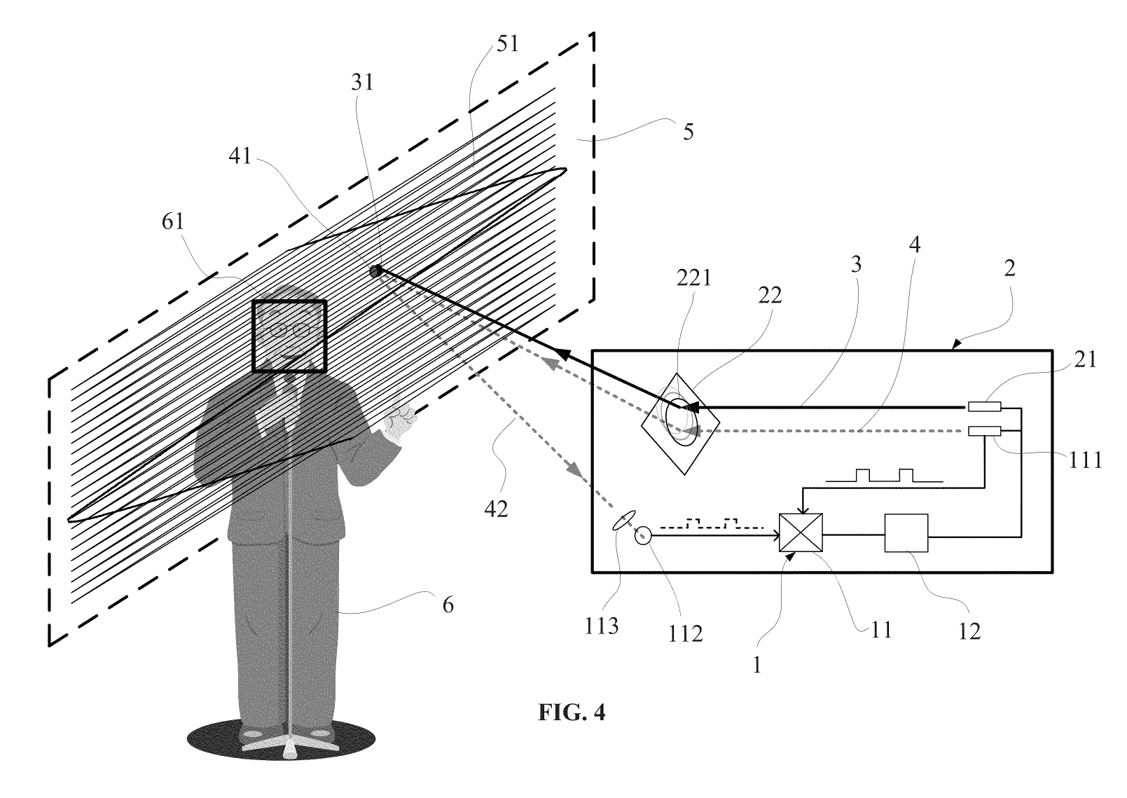

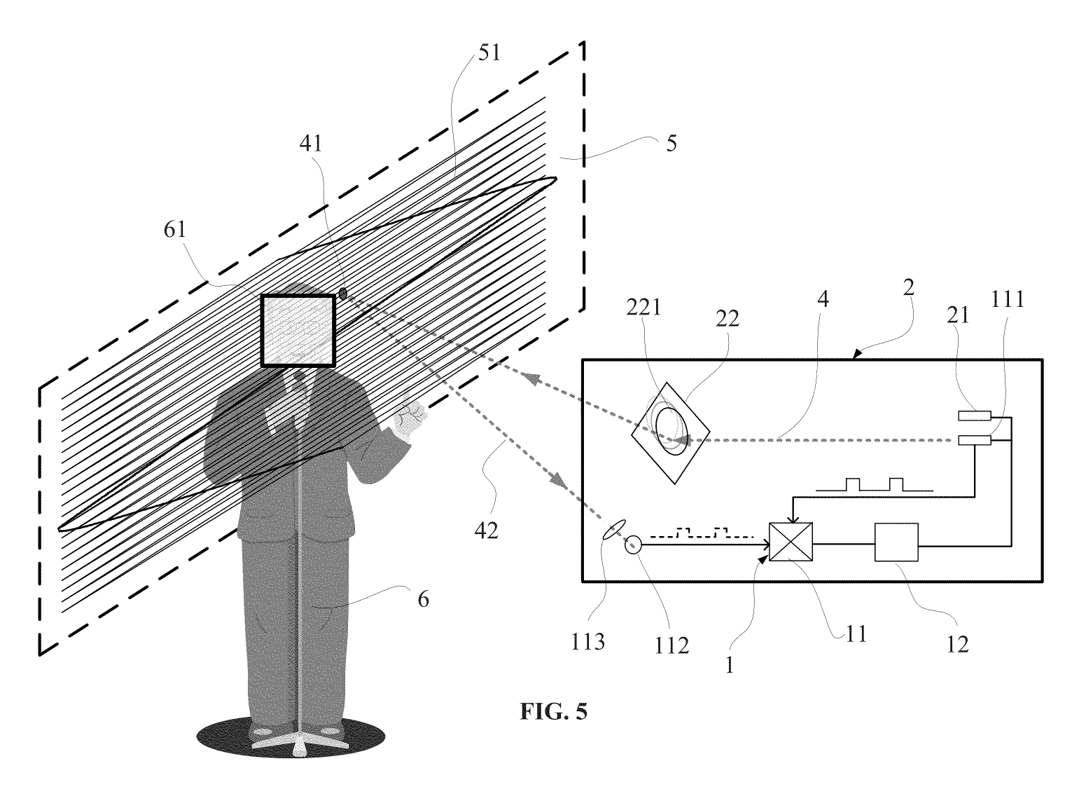

FIGS. 4 and 5 illustrate another schematic view and a further schematic view of the first preferred embodiment of the device for protecting eyes according to the present invention, respectively. The device 1 for protecting eyes can at least determine whether an eye region 61 of a user 6 is located in the scanning region 5 when the user 6 is between the optical apparatus 2 and the scanning region 5. If the eye region 61 is located in the scanning region 5, then the device 1 for protecting eyes can make the optical apparatus 2 stop emitting the visible light beam 3 to the eye region 61 of the user 6 temporarily so that the eye region 61 of the user 6 will not be hurt due to the illumination of the visible light beam 3.

The range of the eye region 61 is adjustable, and in this embodiment, the eye region 61 at least covers the forehead to the jaw of the user 6. If more protection effect is desired, the eye region 61 may cover a larger range; if more projection effect is desired, the eye region 61 may only cover the eyes of the user 6.

Hereinbelow, the device 1 for protecting eyes will be further described.

The device 1 for protecting eyes may be built into the optical apparatus 2. In other words, the device 1 for protecting eyes may be used as a component of the optical apparatus 2 and disposed in the housing of the optical apparatus 2 (such as a penholder of the laser pointer or a casing of the projector). The device 1 for protecting eyes comprises an eye identifying module 11 and a controlling module 12.

The eye identifying module 11 is used to determine at least one eye region 61 in the scanning region 5. If there are a plurality of eye regions 61 in the scanning region 5 (i.e., there are a plurality of users 6 between the optical apparatus 2 and the scanning region 5), the eye identifying module 11 can also determine the positions of the eye regions 61 in the scanning region 5 respectively.

The eye identifying module 11 may be electrically connected to the scanning-mirror component 22 of the optical apparatus 2, and may have an invisible light source 111, at least one invisible light sensor 112 and a light-concentrating lens 113. The invisible light source 111 can emit an invisible light beam 4 such as an infrared (IR) laser light beam or an ultraviolet (UV) laser light beam, so the invisible light source 111 may comprise an infrared light generator or an ultraviolet light generator. The invisible light source 111 can be optically coupled to the scanning-minor component 22 of the optical apparatus 2, so the invisible light beam 4 emitted from the invisible light source 111 can arrive at the scanning-minor component 22.

When arriving at the scanning-mirror component 22, the invisible light beam 4 will be reflected by the reflector 221 of the scanning-minor component 22 so that the invisible light beam 4 is emitted to the scanning region 5 to form an invisible light spot 41 in the scanning region 5. When the reflector 221 of the scanning-mirror component 22 rotates, the invisible light spot 41 formed on the scanning region 5 will move correspondingly.

In this embodiment, an optical path of the invisible light beam 4 is parallel to and in close proximity to (or overlapping with) that of the visible light beam 3, so a moving trace of the invisible light spot 41 will be consistent with that of the visible light spot 31. In other words, the invisible light spot 41 will also move along the scanning trace 51.

If the visible light source 21 and the invisible light source 111 simultaneously emit the visible light beam 3 and the invisible light beam 4 respectively, the invisible light beam 4 and the visible light beam 3 can be coupled by the scanning-mirror component 22 to be emitted to the scanning region 5 simultaneously. As a result, the visible light spot 31 and the invisible light spot 41 formed in the scanning region 5 can move along the scanning track 51 simultaneously.

The invisible light sensor 112 can receive a reflective invisible light 42 of the invisible light beam 4 in the scanning region 5. In detail, when impinging on an object (e.g., a projection screen, a wall or the user 6) located in the scanning region 5, the invisible light beam 4 will be reflected by the object to generate a reflective invisible light 42. Then, the reflective invisible light 42 can be sensed by the invisible light sensor 112 to output a sensing signal.

The light-concentrating lens 113 is disposed at a light incident side of the invisible light sensor 112, and is used to concentrate the reflective invisible light 42 so that light intensity of the reflective invisible light 42 illuminated on the invisible light sensor 112 can be enhanced. Thus, the invisible light sensor 112 can sense the reflective invisible light 42 more easily. It shall be appreciated that if the invisible light sensor 112 has a desirable sensing capability (i.e., the invisible light sensor 112 can sense an invisible light with a weak light intensity), then the use of the light-concentrating lens 113 can be omitted.

The eye identifying module 11 can calculate the distance between the eye identifying module 11 and a position of the invisible light spot 41 of the invisible light beam 4 on the scanning region 5 according to a duration from a time point when the invisible light beam 4 is emitted from the invisible light source 111 to a time point when the reflective invisible light 42 is received by the invisible light sensor 112; in other words, the eye identifying module 11 may measure the distance at least through the use of a time-of-flight method. Alternatively, the eye identifying module 11 may also measure the distance through the use of a phase-difference method or through a triangulation method.

The distance between the invisible light spot 41 and the eye identifying module 11 can be derived in the aforesaid way. The positional coordinates of the invisible light spot 41 in the scanning region 5 can be derived according to the rotation angle of the reflector 221 of the scanning-mirror component 22. After the distances between all the invisible light spots 41 on the scanning trace 51 and the eye identifying module 11 have been obtained, the eye identifying module 11 can, on the basis of these distances and the positional coordinates of the invisible light spots 41, construct a three dimensional (3D) virtual model of the object in the scanning region 5, and further determine whether the object is the eye region 61 of the user 6 according to the 3D virtual model.

If it is determined that the object is the eye region 61 of the user 6, then the eye identifying module 11 outputs positional coordinates of the eye region 61 in the scanning region 5.

The controlling module 12 is electrically connected to the eye identifying module 11 and the optical apparatus 2. In detail, the controlling module 12 is electrically connected to the eye identifying module 11 to receive the positional coordinates of the eye region 61 in the scanning region 5. After receiving the positional coordinates, the controlling module 12 generates a controlling signal (i.e., a first controlling signal) to the optical apparatus 2 according to the positional coordinates so that the optical apparatus 2 stops emitting the visible light beam 3 at least within the eye region 61.

In other words, if the visible light spot 31 formed by the visible light beam 3 in the scanning region 5 is about to enter or has already entered the eye region 61, then the optical apparatus 2 makes the visible light source 21 stop emitting the visible light beam 3 temporarily (as shown in FIG. 5). Thus, no visible light beam 3 will be illuminated on the eye region 61 any longer to guarantee that the eye region 61 of the user 6 will not be hurt. In this case, no image is displayed in the eye region 61.

When a user moves the laser pointer and cause the visible light spot 31 enter the eye region 61, the optical apparatus 2 also stops emitting the visible light beam 3. Thus, the eye region 61 would not be emitted by the visible light beam 3 to prevent the eye region 61 of the user 6 from being hurt.

When the visible light spot 31 is about to move or has already moved outside the eye region 61, the controlling module 12 can generate another controlling signal (i.e., a second controlling signal) to the optical apparatus 2 so that the optical apparatus 2 continues to emit the visible light beam 3 outside the eye region 61 (as shown in FIG. 4). Thus, an image displayed outside the eye region 61 can be watched by the audience again.

Because the visible light source 21 is a laser source, the optical apparatus 2 can turn the visible light source 21 on or off immediately after receiving the first controlling signal or the second controlling signal. Thus, that the visible light source 21 delays turning on or off will result in neither the illumination of the visible light beam 3 on the eye region 61 of the user 6, nor the incomplete display of an image outside the eye region 61.

It shall be appreciated that because the invisible light beam 4 is harmless to the eyes, the eye identifying module 11 still allows the invisible light source to continue to emit the invisible light beam 4 instead of turning off the invisible light source when the invisible light beam 4 enters the eye region 61. Furthermore, by allowing the invisible light beam 4 to be emitted continuously, the eye identifying module 11 can sense any change in the position of the eye region 61 immediately and then update the position coordinates of the eye region 61.

In other embodiments, if the eye identifying module 11 determines that the eye region 61 of the user 6 is in the scanning region 5, then the controlling module 12 may output an OFF signal (i.e., a third controlling signal) to the optical apparatus 2 so that the optical apparatus 2 stops emitting the visible light beam 3 to the scanning region 5 no matter whether the visible light beam 3 is currently within the eye region 61 or not. In this way, the user 6 in the scanning region 5 will not be illuminated by any visible light beam 3 no matter how he or she moves.

The optical apparatus 2 stops emitting the visible light beam 3 continuously until the eye region 61 disappears in the scanning region 5. In other words, if the eye identifying module 11 determines that there is no eye region 61 in the scanning region 5, then the controlling module 12 stops outputting the OFF signal so that the optical apparatus 2 can emit the visible light beam 3 to the scanning region 5 again to display an image.

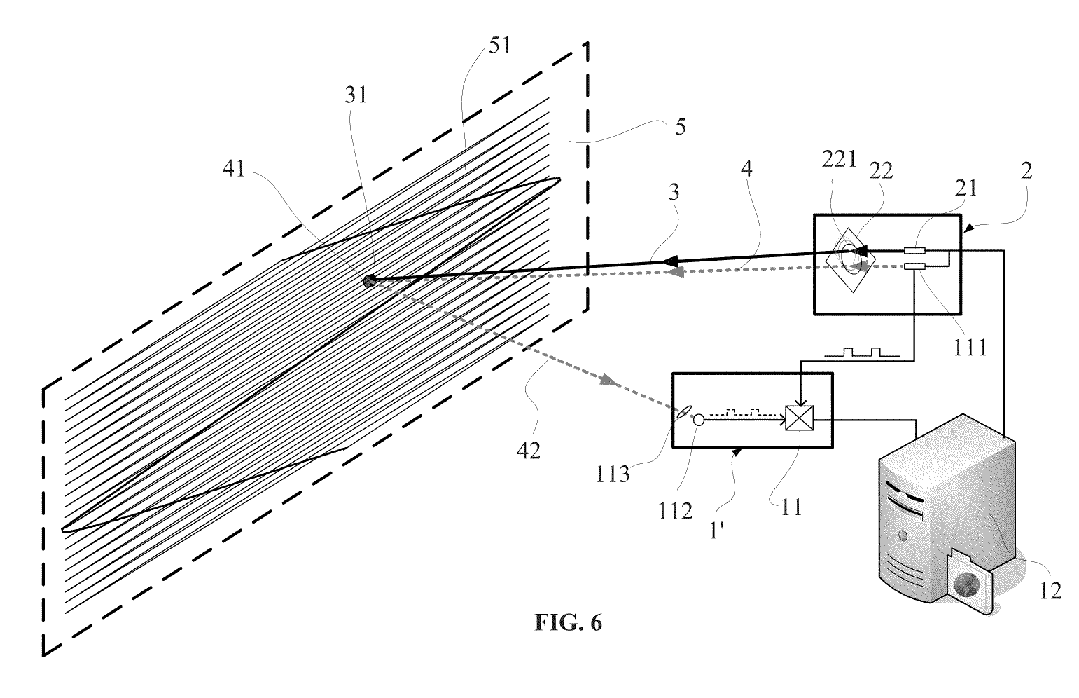

FIG. 6 illustrates a schematic view of the second preferred embodiment of the device for protecting eyes according to the present invention. The device 1′ for protecting eyes according to the second preferred embodiment differs from that of the first preferred embodiment in that the device 1′ for protecting eyes is not wholly built in the optical apparatus 2; instead, the eye identifying module 11 and the controlling module 12 thereof are disposed outside the optical apparatus 2 but are still electrically connected to the optical apparatus 2. Furthermore, the controlling module 12 of the device 1′ for protecting eyes may be a personal computer (PC).

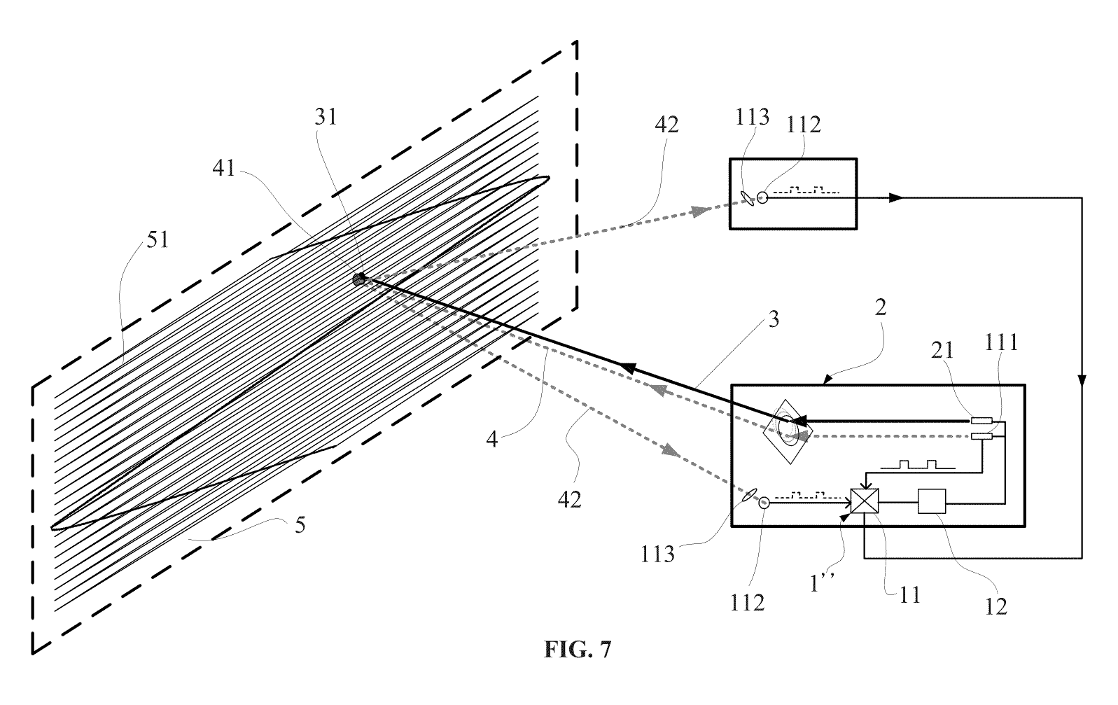

FIG. 7 illustrates a schematic view of the third preferred embodiment of a device for protecting eyes according to the present invention. The device 1″ for protecting eyes according to the third preferred embodiment differs from the device 1 and the device 1′ described in the aforesaid preferred embodiments in that the eye identifying module 11 of the device 1″ for protecting eyes comprises a plurality of invisible light sensors 112 located at different locations respectively. By way of example, one of the invisible light sensors 112 is built in the optical apparatus 2, and another one is disposed above the optical apparatus 2.

The invisible light sensors 112 are used for, from different locations respectively, receiving the reflective invisible light 42 of the invisible light beam 4 in the scanning region 5. Thus, even if the reflective invisible light 42 of the invisible light beam 4 at a certain position of the scanning region 5 can not be sensed by the invisible light sensor 112 disposed in the optical apparatus 2 because of the invisible light sensor 112 being sheltered by something or not located in the optical path of the reflective invisible light 42, the other invisible light sensors 112 at other positions can still sense the reflective invisible light 42 to derive a distance between this position and the eye identifying module 11.

What is described above relates to the embodiments of the device for protecting eyes according to the present invention. Hereinbelow, a method for protecting the eyes of the present invention will be described in detail. The method for protecting eyes may be implemented by at least the aforesaid devices 1, 1′ and 1″.

With reference to FIGS. 1, 2, 4, 5, and 8, FIG. 8 is a flowchart diagram of the preferred embodiment of a method for protecting eyes according to the present invention.

The method for protecting eyes may be used in the optical apparatus 2. The optical apparatus 2 includes the visible light source 21 and the scanning-minor component 22. The visible light source 21 can emit the visible light beam 3 to the scanning-mirror component 22. The scanning-mirror component 22 then reflects the visible light beam 3 to emit the visible light beam 3 to the scanning region 5. The optical apparatus 2 has already been described in detail in the aforesaid embodiments, and thus, will be omitted from description herein.

The method for protecting eyes may be executed after the optical apparatus 2 has been activated. First, step S801 is executed to determine whether there is at least one eye region 61 in the scanning region 5. If the determination result in the step S801 is “no”, this means that no eye region 61 is located in the scanning region 5 (as shown in FIG. 2), and then the step S801 is executed continuously.

If the determination result in the step S801 is “yes”, then step S803 is executed to determine whether the visible light beam 3 emitted from the optical apparatus 2 has been emitted or is about to be emitted to the eye region 61. If the determination result in the step S803 is “yes”, this means that the visible light beam 3 is possibly illuminated in the eye region 61 of the user 6 (as shown in FIG. 5), and then step S805 is executed to generate a controlling signal (i.e., a first controlling signal) to the optical apparatus, 2 so that the optical apparatus 2 stops emitting the visible light beam 3 at least within the eye region 61.

If the determination result in the step S803 is “no”, this means that the visible light beam 3 is still being emitted outside the eye region 61 and will not hurt the eyes of the user 6 (as shown in FIG. 4); and then step S807 is executed to generate another controlling signal (i.e., a second controlling signal) to the optical apparatus 2 so that the optical apparatus 2 continues to emit the visible light beam 3 outside the eye region 61.

Subsequent to step S805 or step S807, step S801 will be executed anew to determine whether the eye region 61 is still in the scanning region 5.

It shall be appreciated that in other embodiments, if the determination result in the step S801 is “yes,” the method for protecting eyes may proceed to the step S805 directly without executing steps S803 and S807. In this way, regardless of whether the visible light beam 3 is emitted to the eye region 61 or not, the method for protecting eyes will make the optical apparatus 2 stop emitting the visible light beam 3 until the eye region 61 disappears in the scanning region 5 (i.e., until the determination result in the step S801 is “no”).

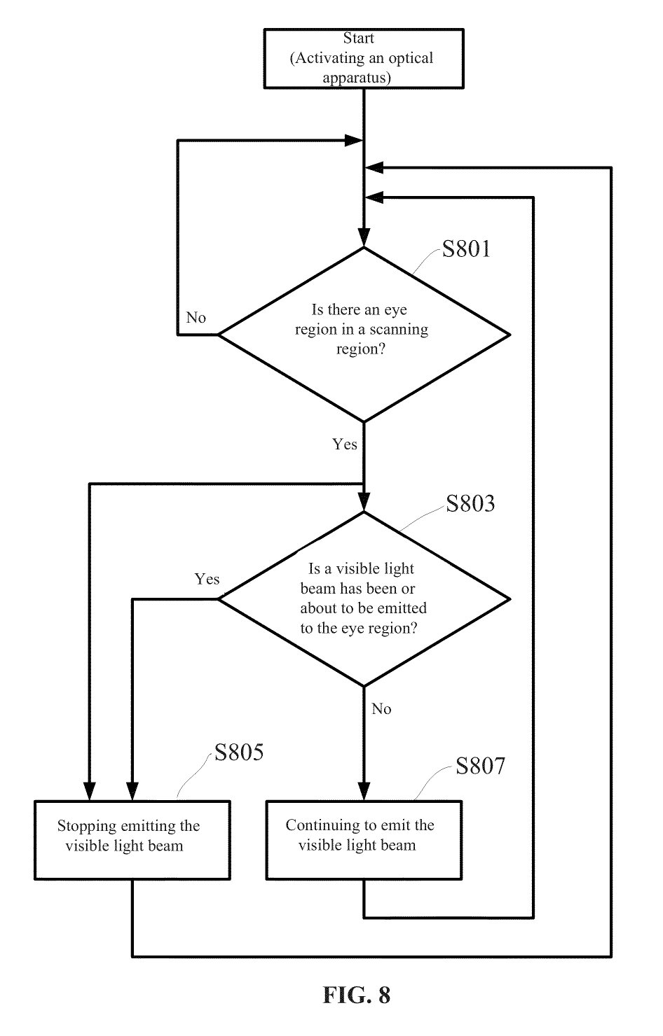

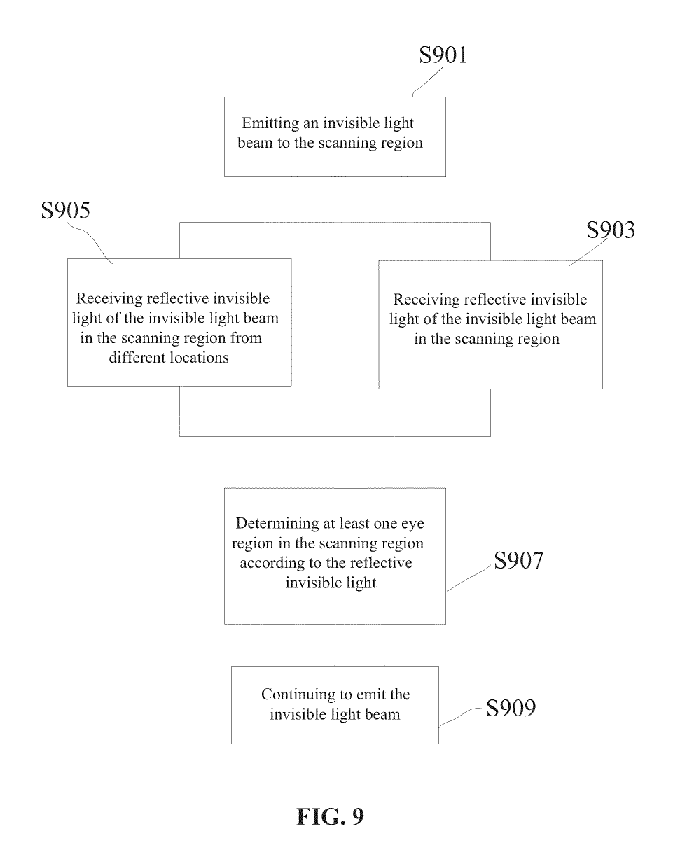

With reference to FIGS. 1, 2, 3, 5 and 9 together, FIG. 9 is a detailed flowchart diagram of step S801 of the method for protecting eyes as shown in FIG. 8. The method for protecting eyes may execute the following steps when determining whether there is an eye region 61 in the scanning region 5 (i.e., the step S801).

First, an invisible light beam 4 is emitted to the scanning region 5 (step S901). The step S901 may be accomplished by use of the invisible light source 111 and the scanning-mirror component 22 of the optical apparatus 2. The invisible light beam 4 and the visible light beam 3 may be simultaneously emitted to the scanning region 5 so that the visible light spot 31 and the invisible light spot 41 formed in the scanning region 5 can move simultaneously.

Next, reflective invisible light 42 of the invisible light beam 4 in the scanning region 5 is received (step S903, as shown in FIG. 2); or reflective invisible light 42 of the invisible light beam 4 in the scanning region 5 is received from different locations respectively (step S905, as shown in FIG. 7). Both steps can be accomplished by use of the invisible light sensor 12.

After step S903 or step S905, the method for protecting eyes determines at least one eye region 61 in the scanning region 5 according to one or more reflective invisible lights 42 (step S907). Then, the invisible light beam 4 is emitted continuously when the invisible light beam 4 moves into the eye region 61 (step S909). In other words, the invisible light beam 4 will continue to emit wherever it is illuminated in the scanning region 5.

According to the above descriptions, the device and method for protecting eyes in the present invention have at least the following characteristics:

1. The device and method for protecting eyes can prevent the visible light beam that is emitted by the optical apparatus from illuminating or make it difficult for the visible light beam to illuminate the eye region of the user so that eyes of the user will not be hurt;

2. The device and method for protecting eyes can make the optical apparatus stop emitting the visible light beam only within the eye region in the scanning region so that regions outside the eye region can still be illuminated by the visible light beam;

3. The device and method for protecting eyes can use the scanning-mirror component of the optical apparatus to emit the invisible light beam so that both the device and the method can be implemented easily; and

4. Because the invisible light beam is harmless to the eyes, it can be emitted to the scanning region continuously so that the device and the method for protecting eyes can monitor the changes of the profiles of objects located in the scanning region at all times.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A device for protecting eyes for an optical apparatus, wherein the optical apparatus includes a scanning-mirror component and a visible light source optically coupled to the scanning-mirror component, the optical apparatus emits a visible light beam to the scanning-minor component by using the visible light source, and the scanning-minor component then reflects the visible light beam to emit the visible light beam to a scanning region, the device comprising:
an eye identifying module for determining at least one eye region in the scanning region, wherein the eye identifying module has an invisible light source optically coupled to the scanning-mirror component for emitting an invisible light beam to the scanning-mirror component, and the scanning-mirror component is used to reflect the invisible light beam so that the invisible light beam and the visible light beam are simultaneously emitted to the scanning region; and
a controlling module, electrically connecting to the eye identifying module and the optical apparatus, wherein the controlling module is used to generate a controlling signal to the optical apparatus so that the optical apparatus stops emitting the visible light beam at least within the eye region.

2. The device of claim 1, wherein the visible light source at least comprises a red visible light beam generator, a green visible light beam generator and a blue visible light beam generator.

3. The device of claim 1, wherein the invisible light source at least comprises an infrared light generator or an ultraviolet light generator.

4. The device of claim 1, wherein the eye identifying module further comprises at least one invisible light sensor for receiving reflective invisible light of the invisible light beam on the scanning region.

5. The device of claim 4, wherein the eye identifying module further comprises a light-concentrating lens which is disposed at an incident side of the invisible light sensor.

6. The device of claim 1, wherein the eye identifying module further comprises a plurality of invisible light sensors for, from different locations respectively, receiving reflective invisible light of the invisible light beam on the scanning region.

7. The device of claim 6, wherein the eye identifying module further comprises a light-concentrating lens which is disposed at a light incident side of one of the invisible light sensors.

8. The device of claim 1, wherein the eye region at least covers a forehead to a jaw of a user.

9. A method for protecting eyes for an optical apparatus, wherein the optical apparatus includes a scanning-mirror component and a visible light source optically coupled to the scanning-mirror component, the optical apparatus emits a visible light beam to the scanning-minor component by using the visible light source, and the scanning-minor component then reflects the visible light beam to emit the visible light beam to a scanning region, the method comprising steps of:
emitting an invisible light beam to the scanning region, wherein the invisible light beam and the visible light beam are simultaneously emitted to the scanning region;
receiving reflective invisible light of the invisible light beam on the scanning region;
determining at least one eye region in the scanning region according to the reflective invisible light; and
generating a controlling signal to the optical apparatus so that the optical apparatus stops emitting the visible light beam at least within the eye region.

10. The method of claim 9, further comprising a step of: generating another controlling signal to the optical apparatus so that the optical apparatus continues to emit the visible light beam outside the eye region.

11. The method of claim 9, wherein the optical apparatus stops emitting the visible light beam until the eye region disappears in the scanning region.

12. The method of claim 9, further comprising a step of: receiving the reflective invisible light of the invisible light beam on the scanning region from different locations.

13. The method of claim 9, further comprising a step of: continuing to emit the invisible light beam when the invisible light beam moves into the eye region.
